(19) United States
(12) Patent Application Publication
(10) Pub. No.: US 2007/0226124 A1
(43) Pub. Date: Sep. 27, 2007

(54) Reducing Pendency of Accounts Receivable

(76) Inventor: Nader Khaghani, Gilroy, CA (US)

Correspondence Address: STRATEGIC PATENT GROUP, P.C., P.O. BOX 1329, MOUNTAIN VIEW, CA, 94042, US

(21) Appl. No.: 11/574,221

(22) PCT Filed: Aug. 11, 2005
(86) PCT No.: PCT/US05/28797

§ 371 Date: Feb. 23, 2007

Related U.S. Application Data
(60) Provisional application No. 60/606,399, filed on Aug. 31, 2004.

(51) Int. Cl. G06Q 30/00

(52) U.S. Cl. 705/37; 705/30

(57) ABSTRACT

The present invention provides a computer-implemented method for reducing pendency for accounts receivable. Method and system aspects of the present invention include receiving by a trading service accessible over a network a submission of AR and AP from the companies; and paying the AP of each of the companies to an extent of available AR by the trading service trading the AP for the AR with other companies in the network, thereby paying the AP through a non-cash settlement.

### FIELD OF THE INVENTION

The present invention relates to a method for settling accounts payable and more specifically to a method and system for reducing pendency of accounts receivable.

### BACKGROUND OF THE INVENTION

Currently, companies have billions of dollars tied up in books of record referred to as general ledger/& sub-ledgers accounts receivable and accounts payable. In an accounting system, entries in the accounts receivable (AR) ledger represent amounts of money a company is owed, typically as the result of the sale of goods and services that a company provides. The AR is treated as a current asset on a balance sheet. Entries in the accounts payable (AP) ledger are debts the company owes resulting from purchasing goods and services from a vendor. This AP appears on the company's balance sheet as a current liability, since the expectation is that the liability will be fulfilled in less than a year. When accounts payable are paid off, it represents a negative cash flow for the company. Almost universally, companies incur a 30-60 days pendency period for AR, and the AP can remain on the books for as late as 50-60 days.

The prolonged time lapse of 30 to 60 days that it takes to collect the accounts receivable, poses a pandemic cash flow problem for all businesses. Present technology offers several options to the timing issue inherent in accounts receivable (AR). Companies can utilize factoring, which has typically high rates of interest 8-17% and aggressive collection policies that can strain loyal customer relationships. Another option is to use the AR as collateral and acquire a loan usually in form of a note payable, which again presents a high rate of interest. The other choices available include outsourcing the AR which again requires interest payment. Securitization that entails forming a trust for the AR and issuing negotiable instrument for the balance is no exception to interest payment. All these methods of settling AP have cash in common.

Although many traditional solutions already exists in the AR market that use conventional models such as discounting, factoring, securitizing, and outsourcing, they almost always involve interest expense and cash payment, in fact, they leave the time gap of 30-60 days in place. To avoid interest expense, the last course of action is to take no action. That is, the company simply waits the 30-60 days it takes to collect the cash locked up in the AR. Meanwhile, cash flow needs of the business are not met and are exacerbated by this time delay in collection.

Accordingly, what is needed is an improved method and system for reducing pendency of accounts receivable. The present invention addresses such a need.

### BRIEF SUMMARY OF THE INVENTION

The present invention provides a computer-implemented method for reducing pendency for accounts receivable. Method and system aspects of the present invention include receiving by a trading service accessible over a network a submission of AR and AP from the companies; and paying the AP of each of the companies to an extent of available AR by the trading service trading the AP for the AR with other companies in the network, thereby paying the AP through a non-cash settlement.

According to the method and system disclosed herein, the present invention provides a solution to the problem of delay inherent in the accounts receivable and turns passive AR into a dynamic asset similar to cash at no interest expense. In addition, because the trading service allows a company to settle its debt with its uncollected AR, the company may conserve cash for payment of payroll or investment in a longer term and higher yield portfolio.

### BRIEF DESCRIPTION OF SEVERAL VIEWS OF THE DRAWINGS

FIG. 1 is a flow diagram illustrating a process for minimizing pendency of accounts receivables in accordance with preferred embodiment of present invention.

FIGS. 2A and 2B are diagrams illustrating an example of a client company (A) using its AR to pay for its AP in accordance with the present invention.

FIG. 3 is a block diagram illustrating a trading system for minimizing pendency of accounts receivable in accordance with a preferred embodiment of the present invention.

FIG. 4 is a block diagram illustrating components of the trading application.

FIGS. 5A and 5B are a block diagrams illustrating example types of trading system rules and covenants, respectively, included in the rules component.

FIG. 6A is a diagram illustrating an exemplary processing flow for the APART trading system in accordance with a preferred embodiment.

FIG. 6B is a diagram illustrating the trade execution process in accordance with a preferred embodiment.

FIGS. 7-20 are diagram illustrating an example of the APART trading service 114 trading the AR/AP of the three client companies A, B, and C, where FIGS. 8-13 illustrate trade processing for company A; FIGS. 14-19 are diagrams showing a continuation of the process with respect to companies B and C; and FIG. 20 is a diagram illustrating the result of the trading execution process for companies A, B, and C.

FIGS. 21A, 21B, and 21C are diagrams illustrating exemplary output reports for the trading process.

### DETAILED DESCRIPTION OF THE INVENTION

The present invention relates to a method and system for reducing pendency of accounts receivable. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

The present invention enables a group of companies frustrated with the receivable-into-cash time delay to minimize the typical 30-60 days pendency period for accounts receivable (AR) and the typical 50-60 days period of accounts payable (AP) by providing a cashless trading system that elevates current AR assets to the same status as cash. According to the preferred embodiment, the trading system allows a particular company to settle an AP owed to a second company by transferring AR to the second company using invoices-sent-out-yet-uncollected (AR) for settlement of invoices-received-yet-unpaid (AP).

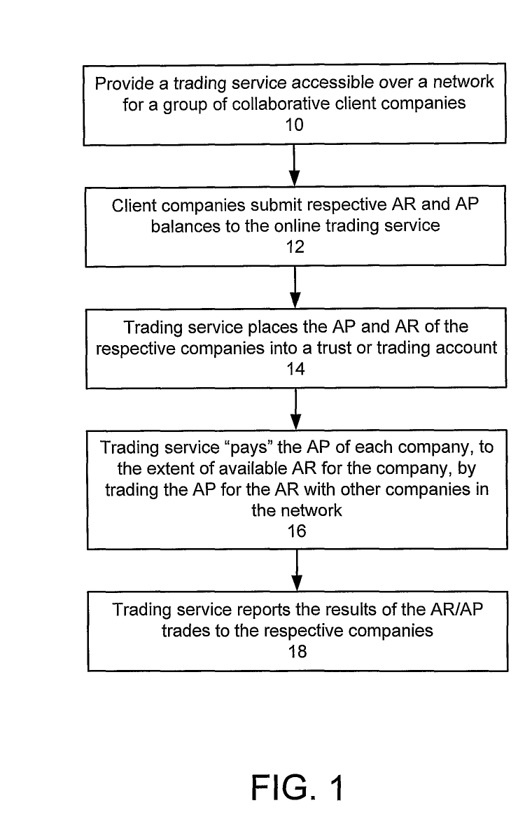

FIG. 1 is a flow diagram illustrating a process for minimizing pendency of accounts receivables in accordance with preferred embodiment of present invention. The process begins in step 10 by providing a trading service that accessible over a network to a group of collaborative client companies, which allows the client companies to assign AR/AP entries from their accounts payable (AP) ledger and an accounts receivable (AR) ledger to the trading service for transfer purposes. The term AR/AP as used herein may include invoices. Although the term “company” is used throughout this description, it should be understood that this term as used herein may include, but is not limited to, any type and number of business entities, enterprises, institutions, or organizations that incurs AR and AP.

In step 12, the client companies submit respective AR and AP balances to the online trading service. In step 14, after the trading service receives the submission of AP and AR balances from the respective companies, the trading service places the AP and AR of the respective companies into a trust or trading account. In step 16, the trading service “pays” the AP of each company, to the extent of available AR for the company by trading the AP for the AR from other companies in the network, thereby paying the AP through a non-cash settlement. In step 18, the trading service reports the results of the AR/AP trades to the respective companies.

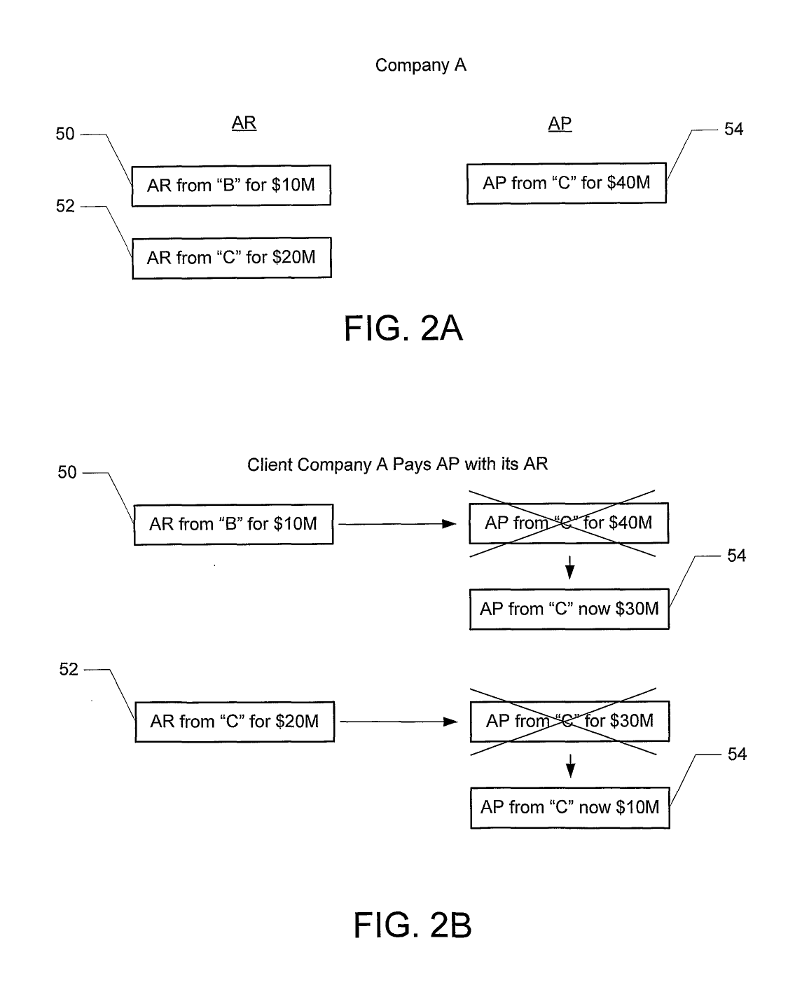

FIGS. 2A and 2B are diagrams illustrating an example of a client company using its AR to pay for its AP in accordance with the present invention. FIG. 2A shows that company A has two AR and one AP; an AR 50 from company B for $10M, an AR 52 from company C for $20M, and an AP 54 for $40M owed to company C. According to the preferred embodiment, company A and C may agree that A can settle its AP to C using the AR 50 and 52. As shown in FIG. 2B, this is done by assigning the AR 50 and 52 from A to C and using the amounts of the AR 50 and 52 to reduce the amount of the AP 54. Once AR 50 from B for $10M is applied against the AP 54C, A's liability to C of $40M is reduced to $30M. Once the AR 52 from C for $20M is applied against the AP 54, A's liability to C of $30M is reduced to $10M.

Thus, the trading service of the present invention provides a solution to the problem of delay inherent in every single AR regardless of size of the company. By enabling AR to serve as a means of payment for AP, passive AR typically waiting to be paid within 30-60 days is now turned into a dynamic asset. The trading system enables companies to minimize the pendency period and trade their AR for AP almost immediately at no interest expense. In addition, by allowing a company to settle its debt with its uncollected AR, the trading service enables the client companies to increase cash flow and conserve cash.

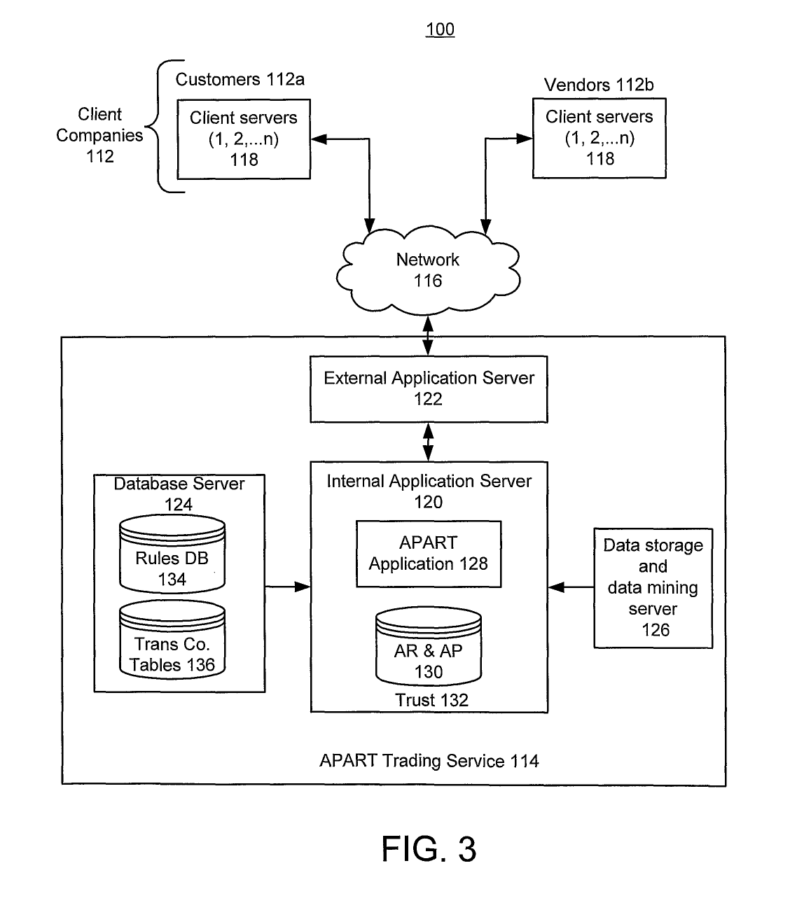

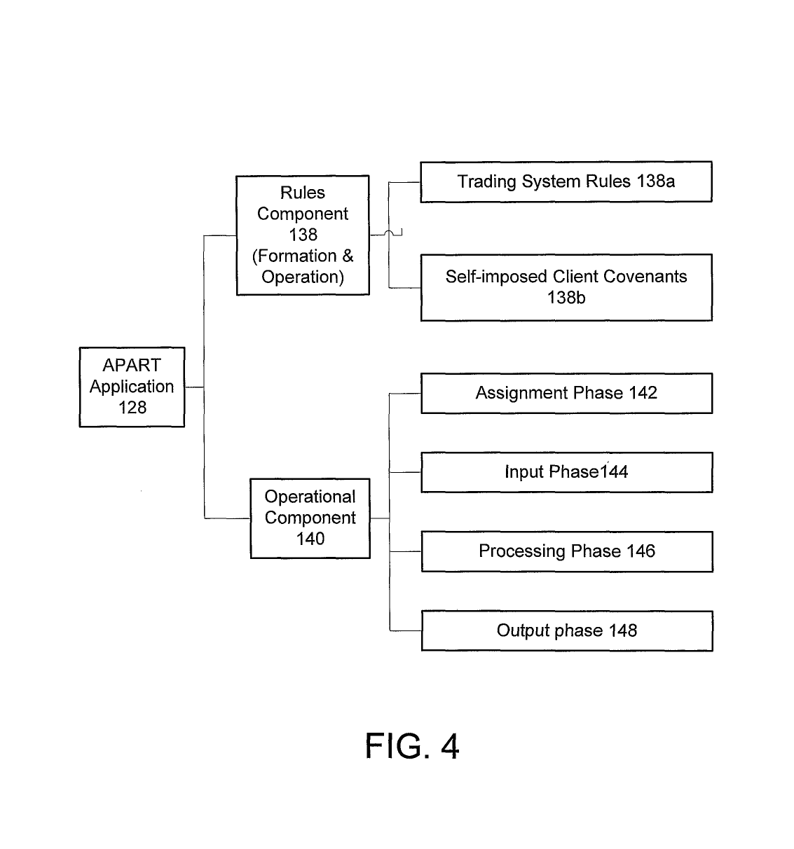

FIG. 3 is a block diagram illustrating a trading system 100 for minimizing pendency of accounts receivable in accordance with a preferred embodiment of the present invention. The trading system 100 comprises a network of collaborative client companies 112 and an accounts receivable accounts payable trust (APART) trading service 114 that enables the client companies 122 to trade their AP and AR among themselves. The client companies 112 may be categorized as being either customers 112a or vendors 112b. A customer 112a represents the purchaser of goods (payer) leading to incurring an AP in their own book of records. A vendor 112b represents the seller of goods or services (payee) leading to earning an AR in their own book of records. A particular company having multiple transactions may have both AP and AR, and will therefore be both a customer 112a and a vendor 112b for the different transactions. Although the client's 112 are described as companies, any entity that has AR and AP may be a client of the trading service 114. Each of the client companies 112 may transmit their AR and AP to the APART trading service 114 over a network 116 using client servers 118. The network 116 may represent a secured closed network, such as an extranet, or a secured (or non-secured) open network, such as the Internet. The trading service 114 may receive an unlimited number of AR/AP from an unlimited number of companies 112 from either the closed network (extranet) or from the open network (Internet). Whether an open or a close system, the method and system for processing the AR/AP as disclosed herein remains the same.

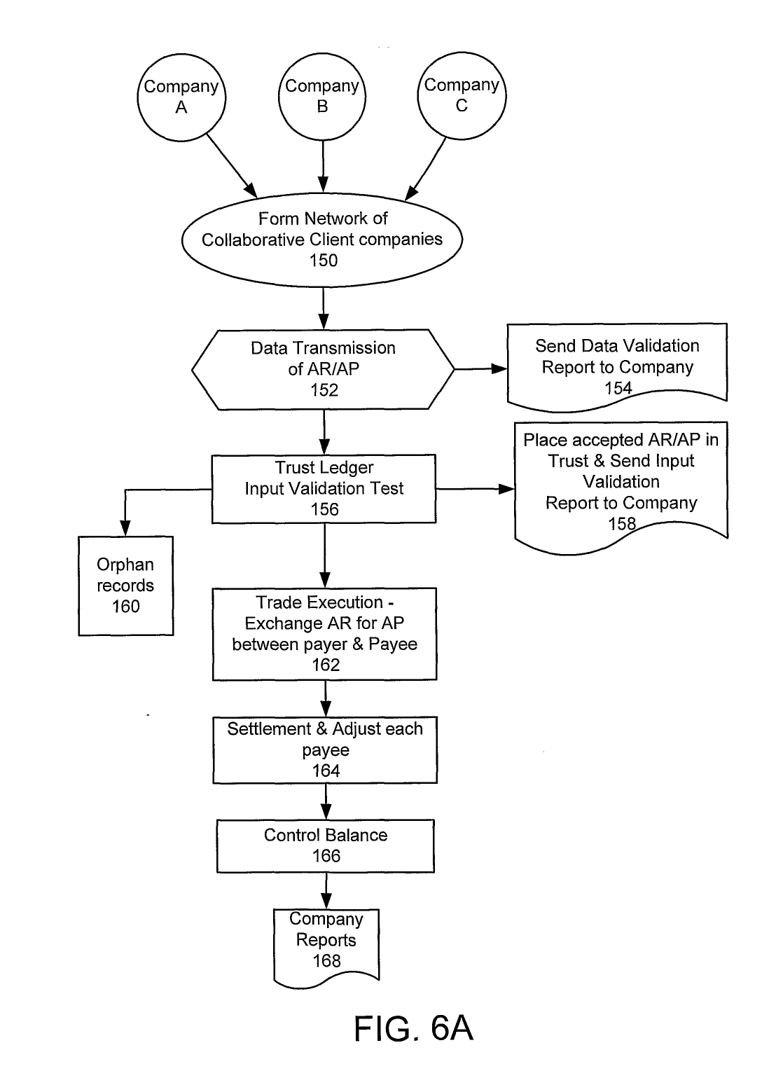

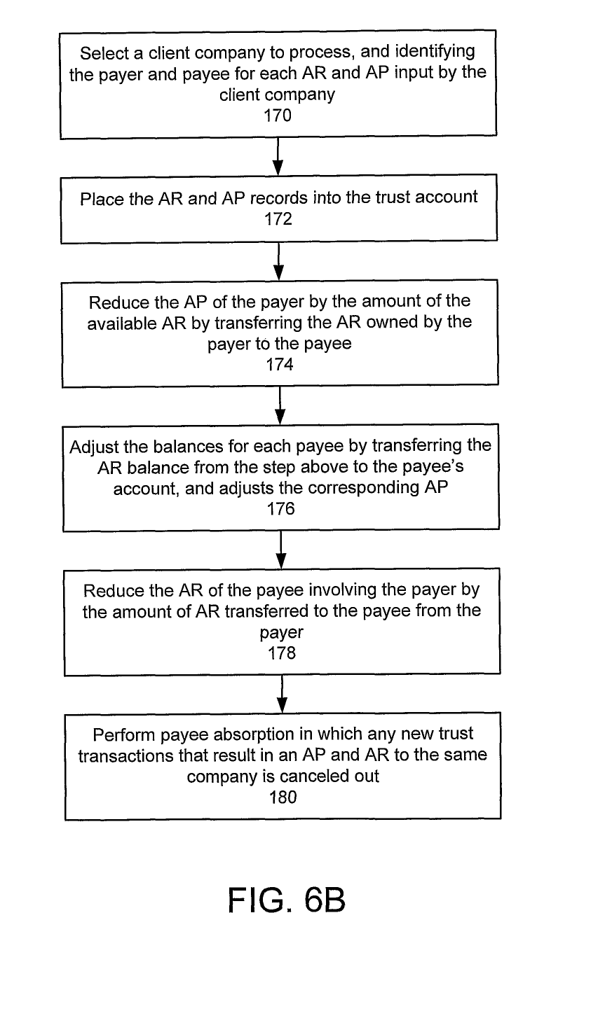

The APART trading service 114 preferably includes an internal application server 120, an external application server 122, a database server 124, and a data storage and data mining server 126. The functionality of the trading service 114 is provided primarily by an APART trading application 128. The APART trading application 128 controls data transmissions between the client companies 112 and the trading service 114, validates input data, executes the AR/AP trades, provides settlement and control balances, and reports the results of the trades to the client companies, as described further with respect to FIGS. 6A and 6B.

Although the APART trading application 128 is shown residing on the internal application server 120, components of the APART trading application 128 may resides on each of the servers 120, 122, 124, and 126. The number and configuration of the servers 120-26 should not be limited to that shown, as the APART trading service 114 could be implemented using additional or fewer servers than shown. In addition, the functionality provided by the APART trading application 128 may be implemented using additional or fewer software applications and/or modules.

The external application server 122 may interface between the client company servers 118 and the internal application server 120. The external application server 122 accepts the AR and AP 130 from the client company servers 118 and stores the received AR and AP in respective transaction company tables 136. If the AR and AP 130 are validated, the AR and AP 130 are placed in a trust account 132 and processed by the APART trading application 128 to generate the trades/transfers, as described below. In an alternative embodiment, rather than a trust account 132 the trading service may create a generic trading account. In either case, the trade transaction take place in an APART account which may be titled trust, trade, or any other name.

The database server 124 may store a rules database 134 containing rules as to operating procedures, and covenants as to agreements among the clients using a closed or open system that control the operations of the trading service 114, and various other tables for storing operating data. An example table may include a table for storing the client company's names and pertinent information, for instance. The data storage and data mining server 126 and a database may also be brought into operation to enable all the client's data and daily trade and settlement activities to be stored. The information contained in the files may be mined fully by the APART trading service 114, or on limited basis by a particular client company 112.

FIG. 4 is a block diagram illustrating components of the trading application 128. The trading application 128 includes a rules component 138 representing the parameters within which the trades can take place, and an operational component 140 defining the day-to-day functioning of the trading service 114. The rules component 138 and the operational component 140 may be stored in the rules database 134.

The rules component 138 may include two types of formation and operation rules, which are referred to as trading system rules 138a and self-imposed client covenants 138b. The trading system rules 138a are rules and externally placed on the trading client that control the formation and operation of the trading service 114. In a preferred embodiment, trading system rules 138a may include rules imposed on client companies 112 that regulate extranet (closed system) implementations, and rules imposed on client companies that regulate Internet (open system) implementations. For example, one rule 138a might require that AR and AP transactions be transferred to the service 114 by 10:00 a.m.

The self-imposed client covenants 138b are rules that are suggested by the trading service 114, but are agreed upon by the client companies 112 when registering with the trading service 114. One example of a self-regulating rule that the client companies 112 may agree upon is an age limit placed on the AR and the AP transferred into the trading service 114.

The operational component 140 includes rules for controlling an assignment phase 142, an input phase 144, a processing phase 146, and an output phase 148. In the assignment phase 142, the collaborating client companies 112 assign their AR and AP to the trading service 114. In one embodiment, the AR and AP are assigned to the trust account 132, while in an alternative embodiment, the AR and AP are assigned to a trading account. An agreement between each of the client companies 112 and the trading service 114 specifies where the assigned AR and AP will be transferred or electronically sent.

In the input phase 144, a trading service 114 receives the AR and AP that are transferred in from the client companies 112 and transfers the AR and AP into the account specified by the agreement between the trading service 114 and the client company 112. The trading service 114 then processes the AR and AP during the processing phase 146, which preferably takes place that night. During the output phase 148, reports showing the results of the trading process may be sent to the respective client companies 112, preferably the next day.

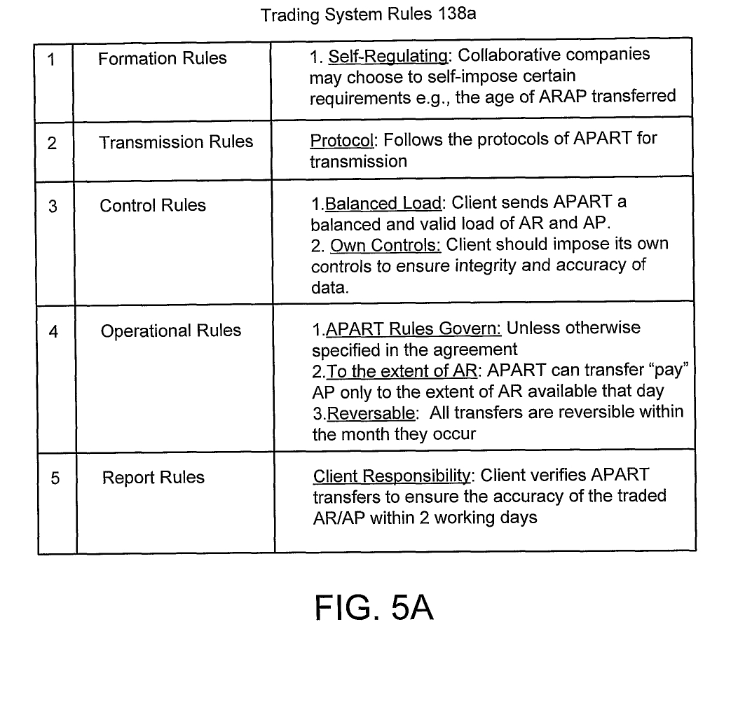

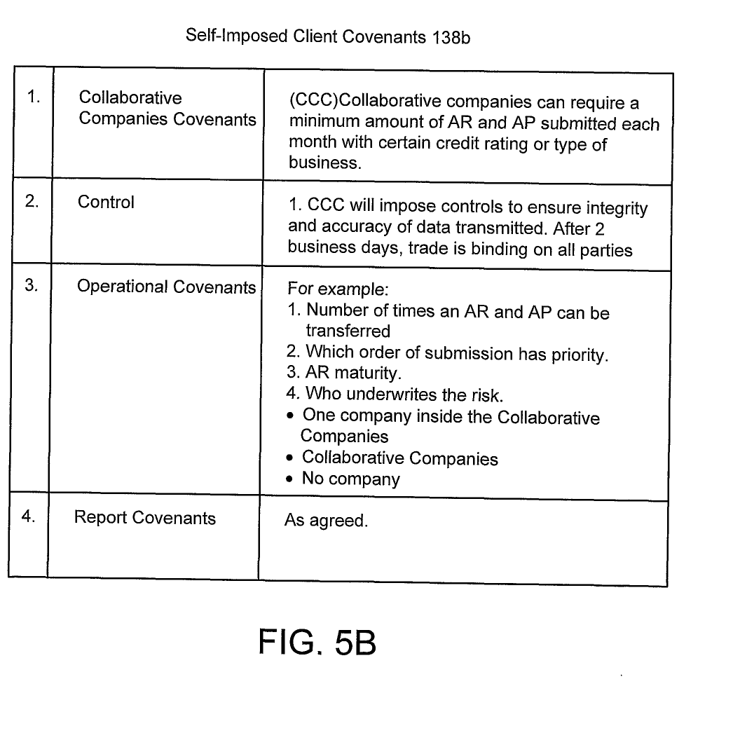

FIG. 5A is a block diagram illustrating example types of trading system rules 138a included in the rules component 138. Example types of trading systems rules 138a include formation rules, transmission rules, control rules, operational rules, and report rules. As described above, one type of formation rules include self-imposed covenants. With self-imposed covenants, the client companies 112 may choose to self-imposed certain requirements for membership and trade, e.g., requiring a credit ratings of AAA, or membership in a certain industry, for instance. Another type of formation rule may include a limit rule that limits AR and AP trades to client companies 112 within the trading system 112.

The transmission rules may include protocols governing the communication protocols for the trading system (e.g., extranet, Internet). The control rules may include balance load rules and owner controls. Balance load rules may, for example, require that a client send the trading service 114 a balanced and valid load of AR and AP, i.e., all the AR and AP of each client company 112 balances to zero. That is, the client not only specifies its own AR balance of for example $30M, but also specifies to whom the AP is owed, thus 30AR−30AP=0. As another example, the balance load rules may require the AR and AP of all the client companies 112 should balance to zero. The owner controls are rules of each of the client companies 112 that the client companies 112 use to ensure integrity and accuracy of the AR and AP transferred into the trading service 114.

The operational rules control the overall AR and AP processing. For example, two major operational rules may dictate that 1) the trading system can transfer/pay AP only to the extent of AR available that day, and 2) all trades/transfers are reversible within the month they occur. Another example of an operational rule is a rule that specifies how the AR is to be paid. For example, the rule may specify which bank is responsible for taking care of the eventual payment for the AR. The operational rules may also reflect an agreement by the client companies that specifies to what extent each of the transaction for a particular client will be made visible to other client companies. The operational rules are established by the trading service 114 and govern, unless otherwise specified in an agreement between client companies. The report rules control how the trading service 114 reports the results of the trades/transfers to the client companies and what responses are required, if any. For example, one report rule may dictate that the client companies 112 must verify the trading system transfers to ensure the accuracy of the traded AR/AP within two working days.

FIG. 5B is a block diagram illustrating example types of self-imposed client covenants 138b included in the rules component 138. Example types of self-imposed client covenants 138b include collaborative companies covenants (CCC), control covenants, operational covenants, and report covenants. Some examples of collaborative company covenants 138b have been described above. Another example is a covenant that the companies 112 may agree upon is one that requires a minimum amount of AR and AP submitted each month with a certain credit rating or type of business. A controlled covenant is one imposed to ensure integrity and accuracy of data transmitted. For example, a controlled covenant may state that after two business days, trade is binding on all parties. Examples of operational covenants are the following: 1) the number of times an AR and AP can be transferred, 2) which order of submission has priority, 3) AR maturity, and 4) the party who underwrites the bad debt risk, a particular one of the client companies 112, any of the client companies 112, or none of the client companies 112. It should be noted that transmission covenants are not applicable. That is, the client companies 112 follow the protocols of the APART trading service 114 for each transmission.

FIG. 6A is a diagram illustrating an exemplary processing flow for the APART trading system 100 in accordance with a preferred embodiment. As described above, the process used by the trading system 100 for reducing pendency of AR has four major phases: the assignment and formation phase (step 150), the input phase (steps 152 and 160) in which data is input and prepared for processing, the processing phase (steps 162-166) in which AP is paid for with AR, and the output phase (step 168) in which trading reports are prepared and delivered, or viewed.

The process for reducing pendency of AR begins in step 150 by forming the network of collaborative client companies 112. The step involves the registration of client companies 112 that have agreed to assign or simply trade AR and AP balances to the APART trust for trading. Companies become network or “looped” client companies 112 of the APART trading service 114 by agreeing to the set of rules and covenants 138a and 138b of the trading service 114. In the example shown, three companies, A, B, and C have agreed to join the trading service 114 and to become a network of collaborative client companies 112. The network formation process may also include the process of setting up client company tables in the database server 124. For example, the identity of each of the client companies 112 and client information may be stored in a company table, while data submitted to the trading service 114 from the client companies 112 may be stored in respective transaction company tables 136.

In a further embodiment, rather than only serving companies that are members of the network, the trading service 114 can also serve companies that are independent and not part of the network, but who are willing to accept other companies AR balance transferred to their APART/client account or the trust account 132 as part of the trade and settlement of their AP.

After network formation, in step 152, each of the client companies 112 performs data transmission in which the client companies 112 transmit their respective AR and AP 130 records to the APART trading service 114 according to the predefined transmission protocol. In a preferred embodiment, after the AR and AP transmissions from the client companies 112 are received by the external application server 122, the external application server 122 stores the AR and AP of each of the client companies 112 in the respective transaction company tables 136 (FIG. 3). The external application server 122 also verifies that the completeness and integrity of the data according to standard protocols, and returns a data validation report to the corresponding client company 112 in step 54.

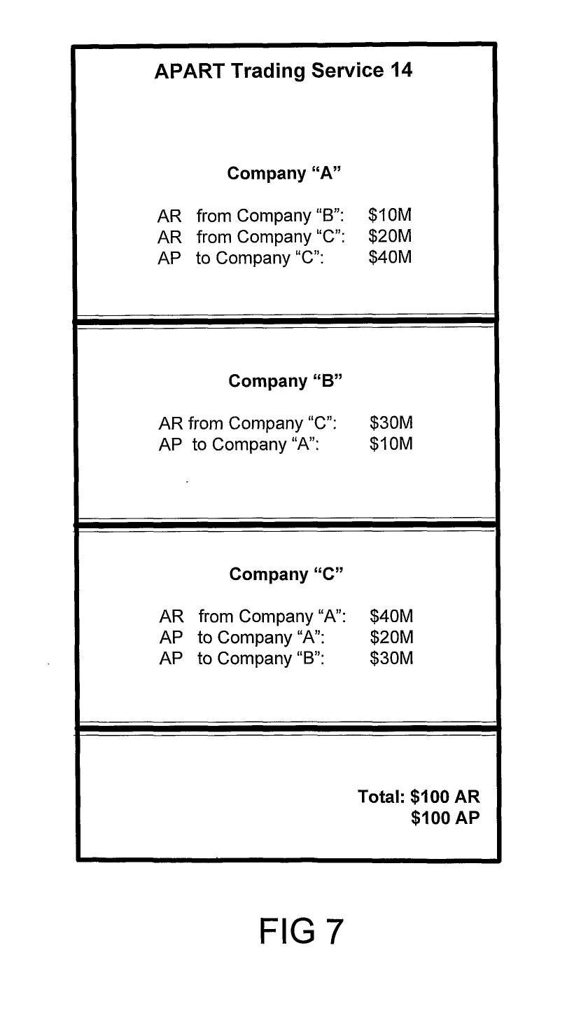

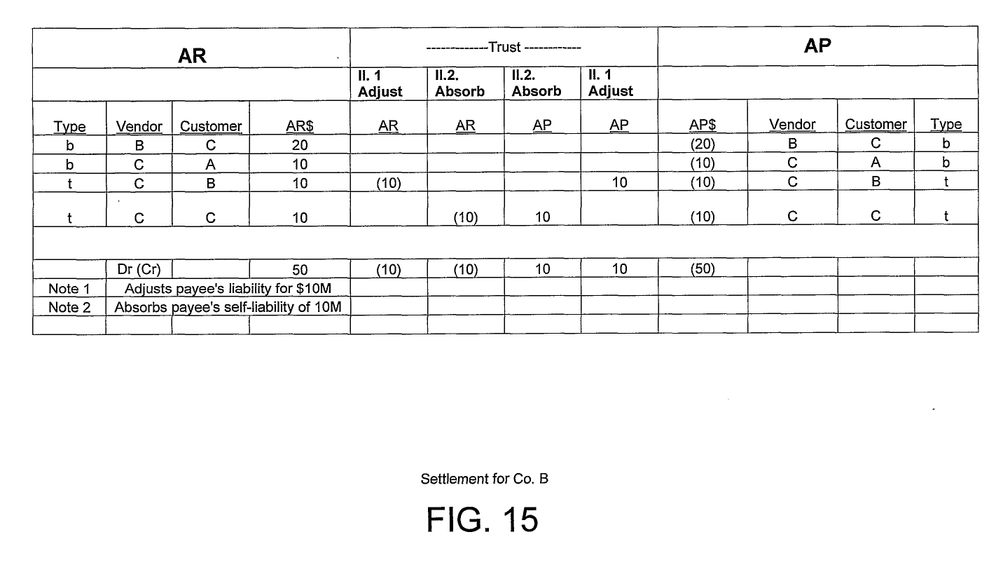

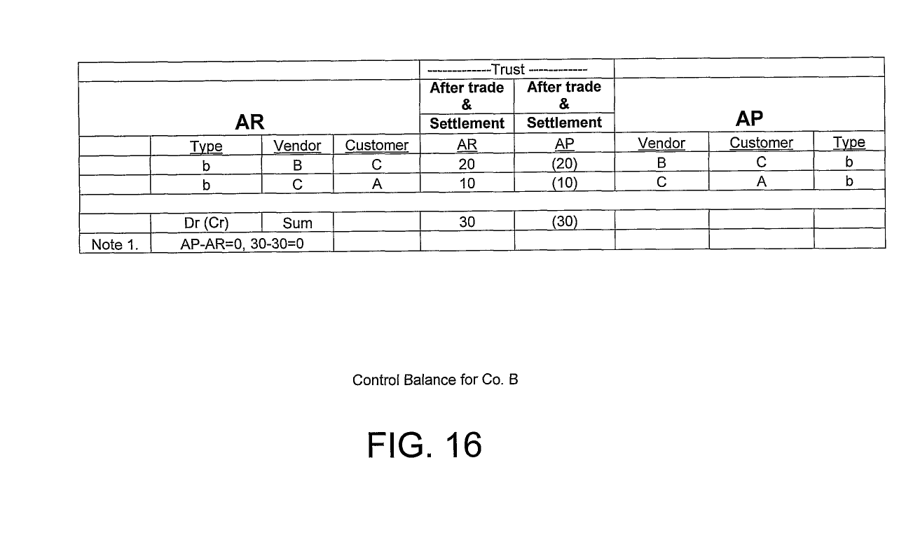

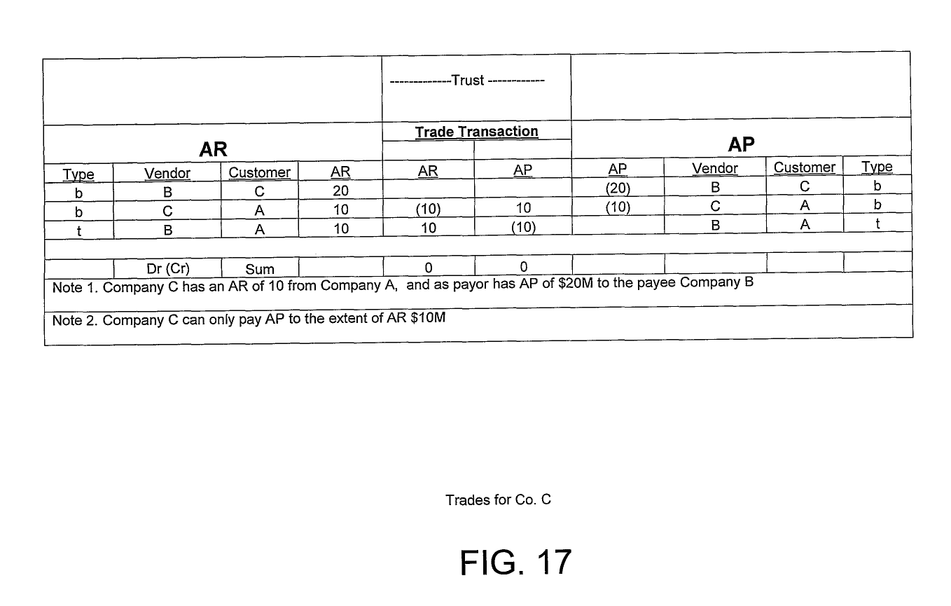

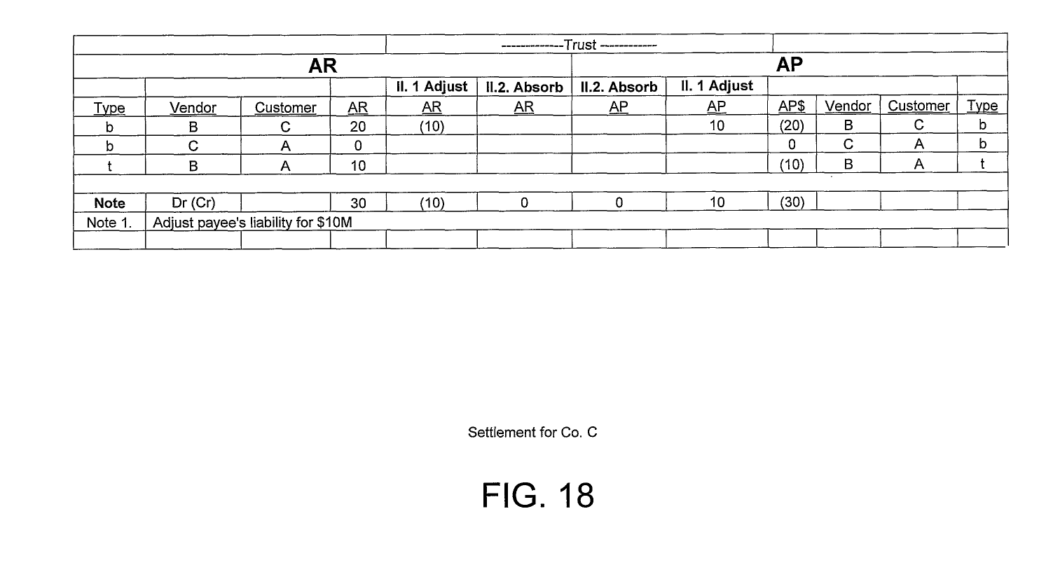

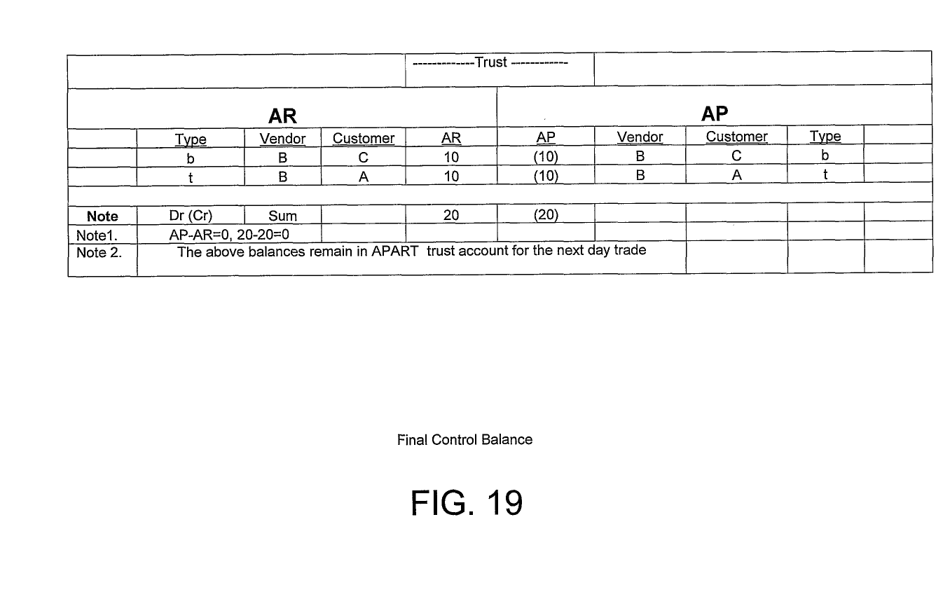

FIGS. 7-21C are diagram illustrating an example of the APART trading service 114 trading the AR/AP of the three client companies A, B, and C. FIG. 7 shows the exemplary AR/AP submitted from three companies A, B, and C for input into the trading service 114 as follows:

Company A submits 2 AR ($10M from B, and $20M from C).

Company A submits 1 AP ($40M to C).

Company B submits 1 AR ($30M from C).

Company B submits 1 AP ($10M to A).

Company C submits 1 AR ($40M from A).

Company C submits 2 AP ($20M to A and 130 to B).

The total AR in the trust is $100M, which equals the total AP $100M. Hence no orphan records will be reported to any client company in the validation phase of APART.

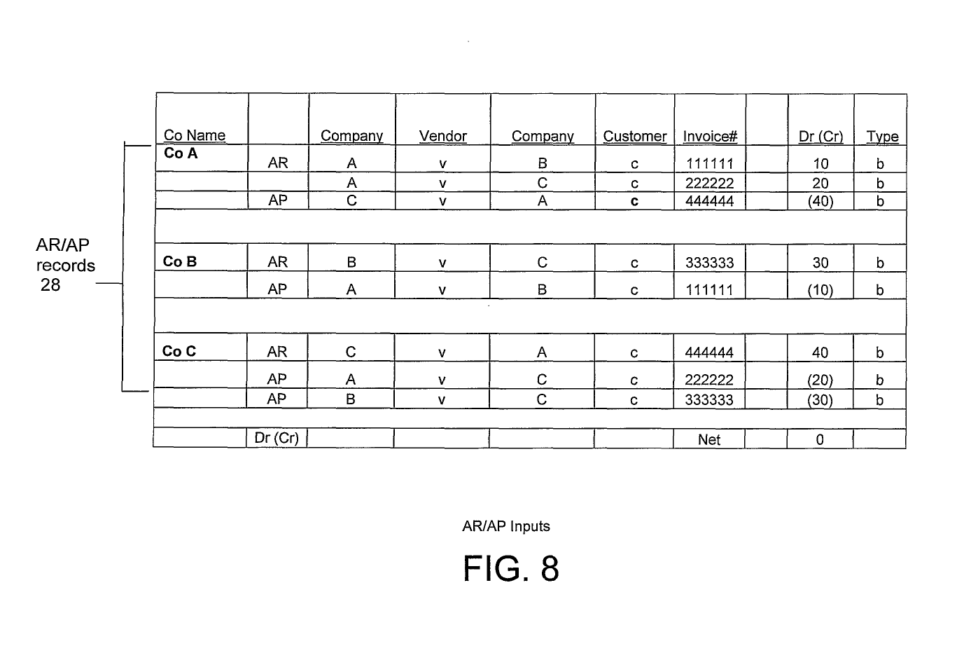

FIG. 8 is a diagram illustrating an example table displayed on a screen or report showing the inputs submitted by each client company 112 on a periodic basis (e.g., daily). The table lists the AR and AP records 128 submitted for each company. Each AR/AP record identifies the names of two companies (or assigned code names) involved in the transaction, and identifies which company 112 is the vendor/payee and which company is the customer/payer. In this particular example, the company that is the vendor is designated with a “v”, and the company that is the customer is designated with a “c”. Each record also may include an invoice number, whether the record is a debit or credit, and the type of AR/AP. In this example, a “b” type separates and distinguishes normal AR/AP originally received in various way (e.g., on-line input screen, excel spread sheet or batch transfer, etc) from “t” type, which are AR/AP acquired due to the trade and settlement activities. Though the information may be obtained through an AR/AP balances, or invoices bundled in such balances or simply invoices, reference to individual invoices number is omitted in the remaining Figures for clarity.

Referring again to FIG. 6A, after the AR and AP records 128 are received and stored in the respective transaction company tables 136, the APART trading application 128 performs input validation tests on the AR and AP records 128 in step 156 to ensure that the AR and AP records are valid, balanced and ready for trading. For example, the validation test may include ensuring that the AR and AP received per client company 112 and per transaction balances to zero, i.e., making sure that for every AP there must be a corresponding AR for each client company 112 and vice versa. Any AR/AP without a match is referred to as an orphan record 160. The validation process may occur either on the internal or external server 120 and 120.

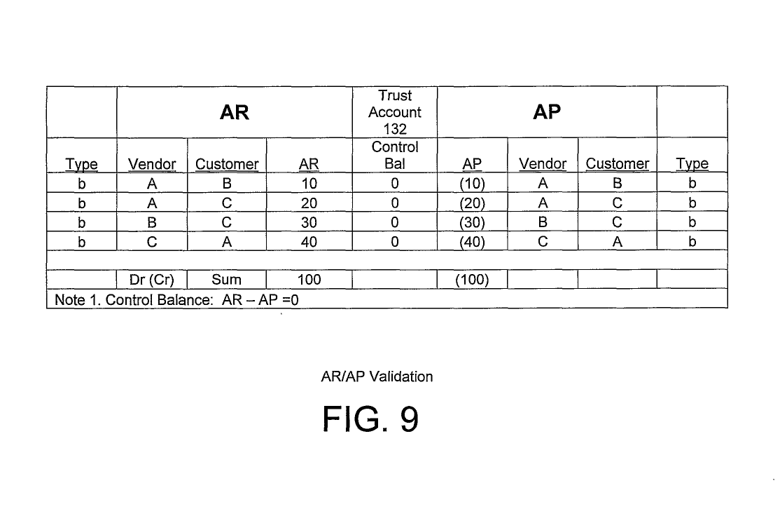

FIG. 9 is a diagram illustrating an example validation process performed on the exemplary AR and AP of companies A, B, and C. During validation, the APART trading application 128 groups all of the input AR records on one side of the table, and groups all of the input AP records on the other sides of the table. The AR and AP records having matching vendor and customer designations are then matched. The values of the matching records are then subtracted to determine the result is zero. For example, in the first listed AR record, A, the designated vendor, is to receive $10M from B, the designated customer, which matches the first listed AP record having the same vendor and customer designations. The net result of the two transactions balance AR−AP=0:

Company A $10M AR from B−10M AP Company B owes to Company A=0

Referring again to FIG. 6A, any unmatched AR/AP at the end of the validation process are placed in an orphan record table 160 for matching during a subsequent validation and processing phase (e.g., the next day). The AR and AP 130 that pass the validation test are accepted and placed in the trust account 132 for processing, and input validation reports are sent to the respective client companies 112 in step 158. The input validation reports preferably identify which AR and AP are accepted for trading and which are unmatched orphans 160.

After validation, the APART trading application 128 performs a trade execution process in which payees and payers in each AR/AP transaction are identified and the AP is paid with AR between the payers and payees in step 162 to the extent of available AR. In step 164, the APART trading application 128 performs a settlement and adjustment process in which for each payee; 1) the payee's account is adjusted for each of the trades, and 2) any self debt (liability) as a result of a trade in which a client exchanges AR/AP to itself is canceled. In step 166, the APART trading application 128 performs a control balance process that ensures a zero balance is maintained after processing each trade and its settlement. In step 168, the APART trading application 128 provides reports to each client company 112 informing them of the trades/transfers of AR and AP. In a preferred embodiment, the report to each client company 112 may specify input, payment, and ending balances.

Referring now to FIG. 6B, a flow diagram illustrating the details of the trade execution process is shown in accordance with a preferred embodiment. The APART trading application 120 begins the trade execution process in step 170 by the selecting a client company 112 to process, and identifying the payer and payee for each AR and AP 130 input by the client company 112. The payer is the company that owes the AP and hence pays with its AR, while the payee is the company to whom the AP is owed and hence receives the AR in lieu of the debt. Referring again to FIG. 9 for example, company A's AR and AP, company A is designated as the vendor, i.e., payee, for A's AR, and company C is designated as the customer, i.e. payer for A's AP. At this point in the process, no AR/AP records have been input into the trust account 132.

After the AR/AP payees and payers are identified, the AR and AP records 130 are placed into the trust account 132 in step 172. In step 174, the APART trading application 128 reduces the AP of the payer (the company which is settling its AP to the extent of its AR) by the amount of the available AR by transferring the AR owned by the payer to the payee (to the limit of the AP amount).

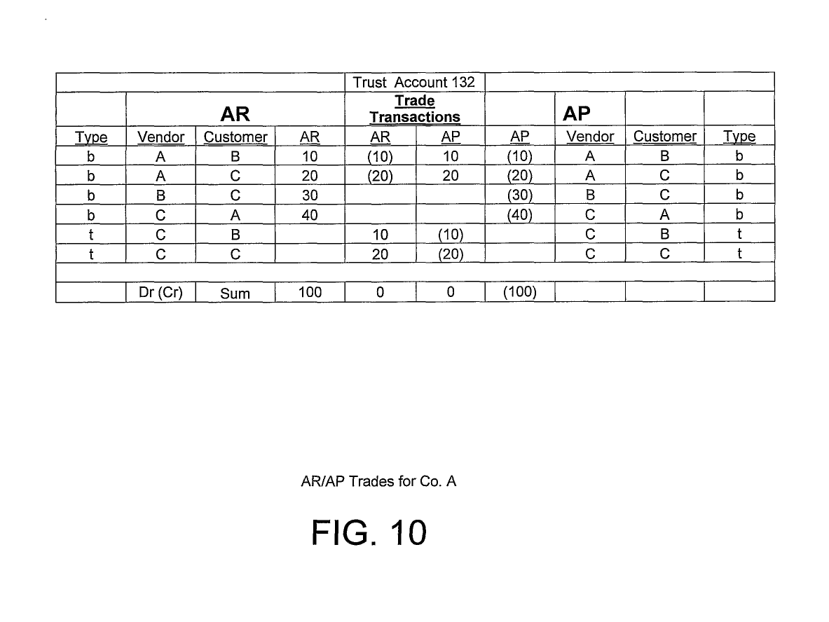

FIG. 10 is a diagram illustrating the AR and AP records 130 of company A added to the trust account 132 and traded. Records designated as type “b” indicate business AR/AP, which is in the original data received from the client companies 112, and records designated as type “t” designation indicate AR/AP for each company that were gained through a trade in the trust account 132. The purpose of the trade account 132 is to pay the AP of the payer, company A, by transferring the AR of company A to the payee, company C. In this case, company A has one AP owed to company C for $40M. According to the APART rules, the APART trading application 128 can only pay the AP ($40M) to the extent of AR ($10+$20=$30M) available that day. Therefore, the APART trading application 128 creates new trust AR/AP records designated as type “t” (APART traded AR/AP thus distinguished from normal AR/AP generated in normal sale activity) that debits company A's AR of $10, and $20, shown by the (10) and (20) in the AR side of the trust account 132, and credits A's AP for same amount in the AP side of the trust account 132. Company A's AR's and the corresponding AP's are now transferred to company C in lieu of the $40M AP.

Referring again to FIG. 6B, in step 176, the APART trading application 128 adjusts the balances for each payee by transferring the AR balance from the step above to the payee's account, and adjusts the corresponding AP, resulting in the payee assuming the new AR. In step 178, the APART trading application 128 reduces the AR of the payee that involve the payer by the amount of AR transferred to the payee from the payer. In step 180, the APART trading application 128 performs payee absorption in which any new trust transactions that results in an AP and AR to the same company is canceled out because the company has both AR and AP to itself for the same amount.

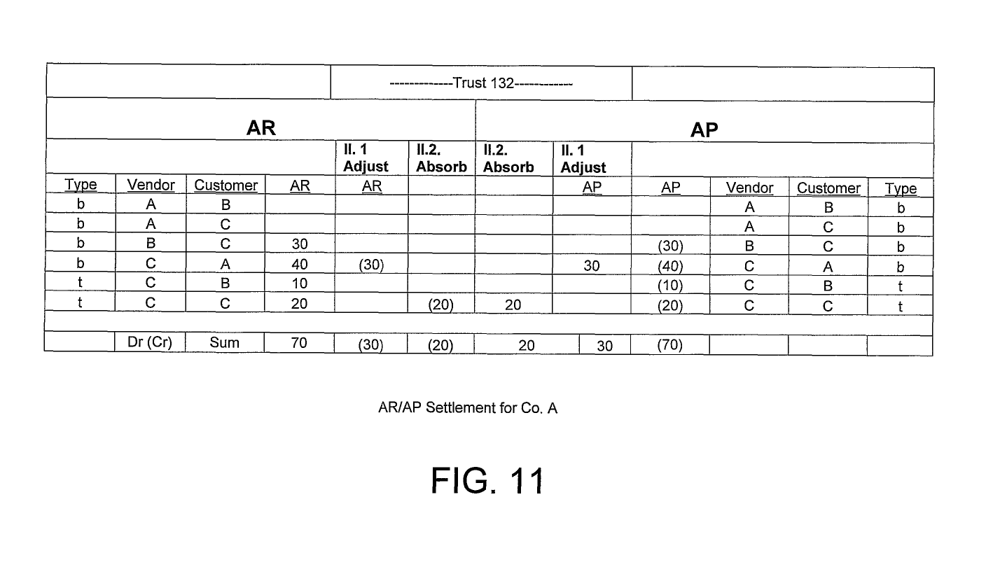

FIG. 11 is a diagram showing the result of the trade causing a reduction in company A's AP to C for $40M by the two AR totaling $30M after steps 176, 178, and 180 are performed. The APART trust account 132 shows the increase in company C's AR due to receipt of new AR transactions transferred from company A. The corresponding AP is also simultaneously increased keeping a net AR/AP balance of zero. The APART trading application 128 reduced the payer's AR in the trust account of the payee by $30M, since the payee has already received AR which was transferred in. The APART trading application 128 simultaneously reduced the corresponding AP to the same extent. Also shown is that one of the new “t” type trust transaction has company C designated as both a vendor and customer/payer and payee. According to one aspect of the preferred embodiment, the APART trading application 128 cancels out (absorbs) the AR and AP when the vendor and customer are the same company.

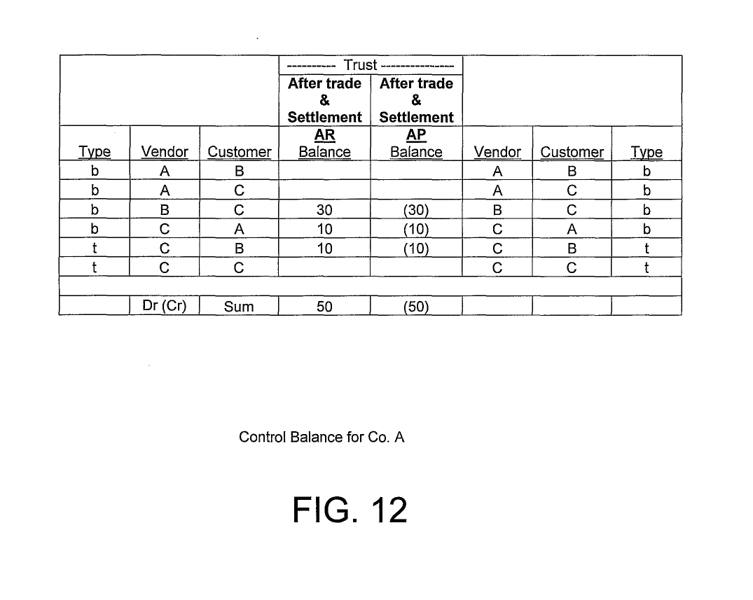

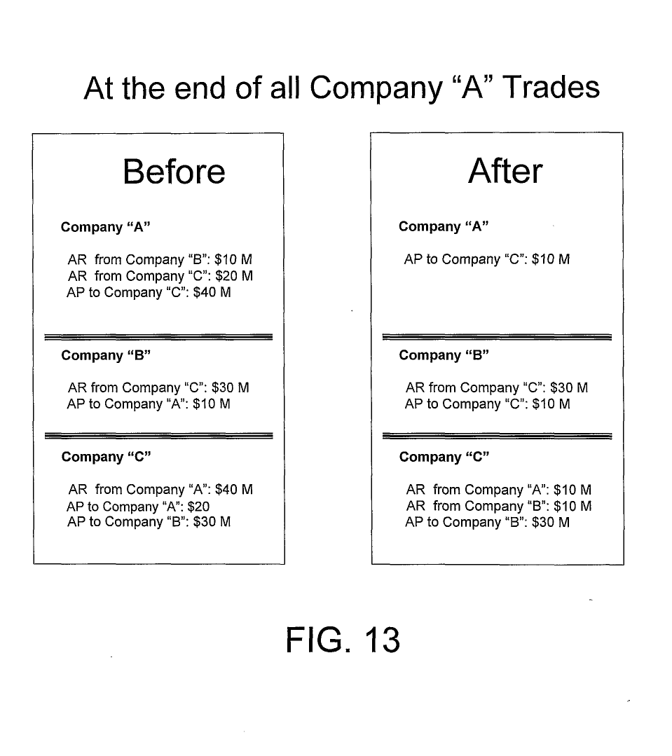

After absorption is performed, the APART trading application 128 performs the control balance process as described in step 166 of FIG. 6A. FIG. 12 is a diagram illustrating the example above after the control balance process is performed. FIG. 13 is a diagram illustrating before and after results of the trading execution process for company A.

The above described steps are repeated until all companies have been analyzed and optimized. After all the companies 112 have been processed (transferred required balances in the trust account 132), the APART trading application 128 reports all the daily transfers back to the client companies 112.

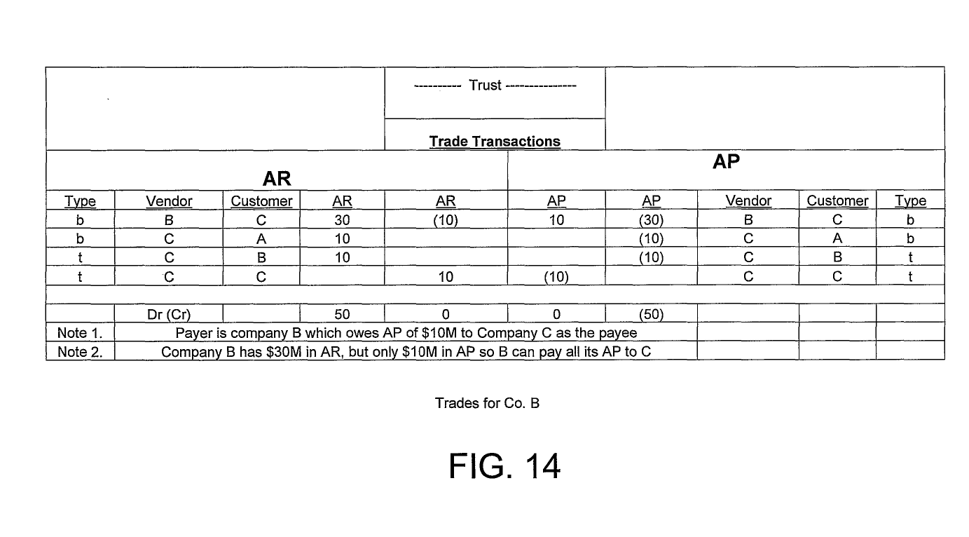

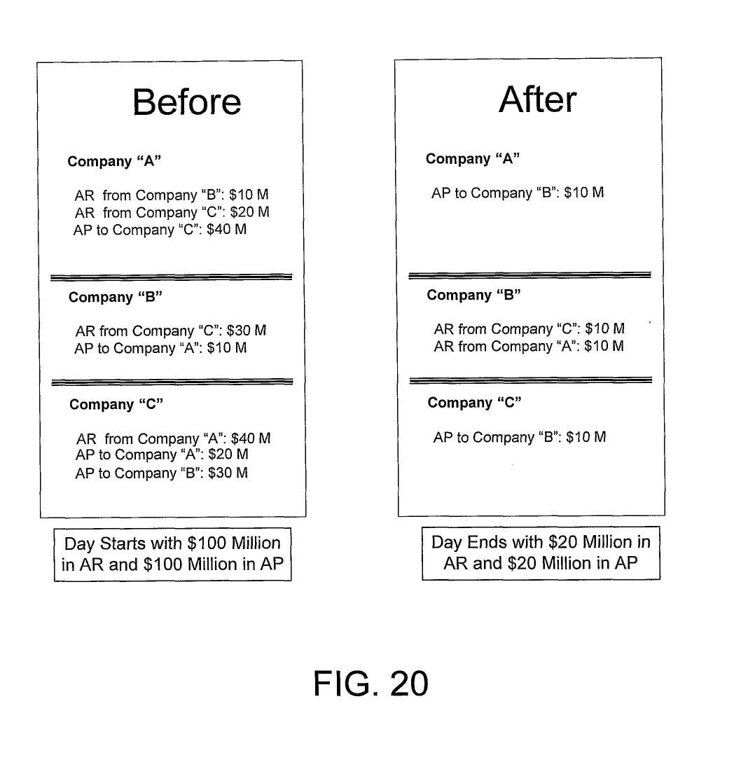

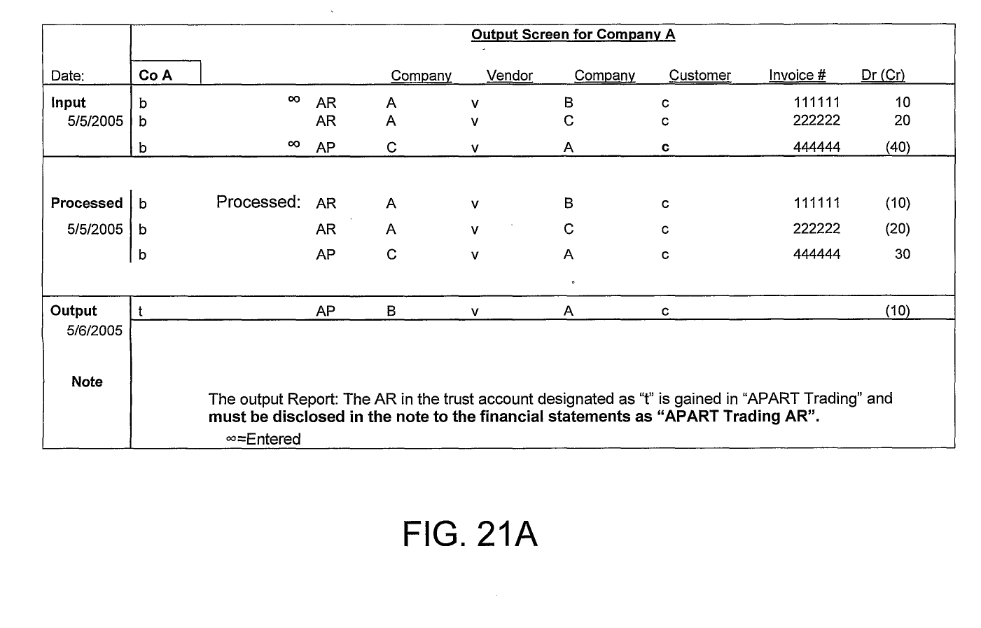

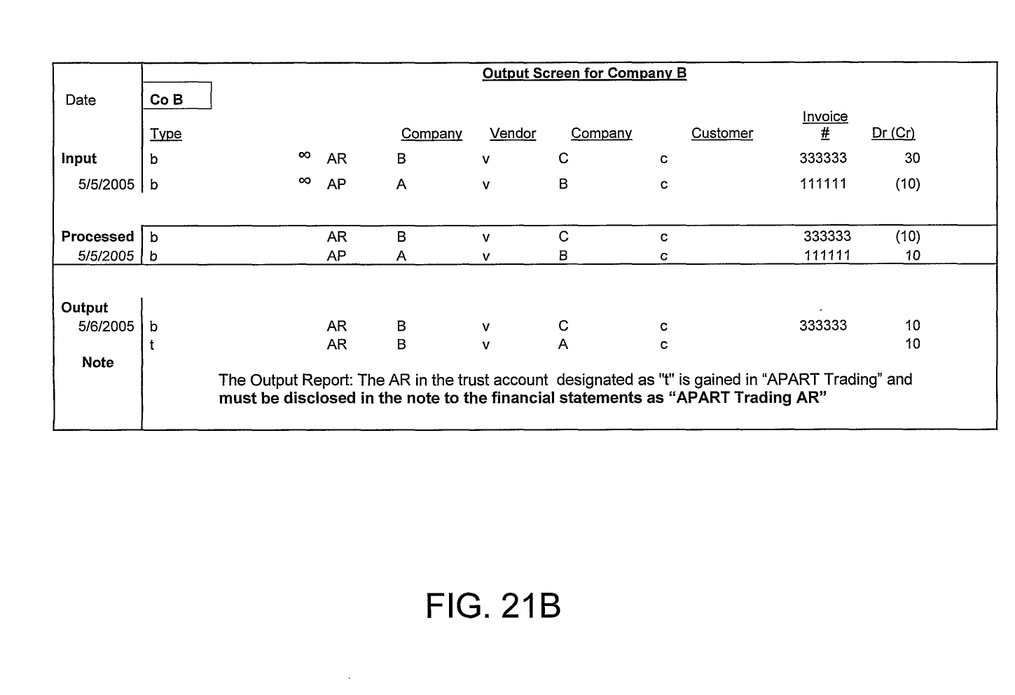

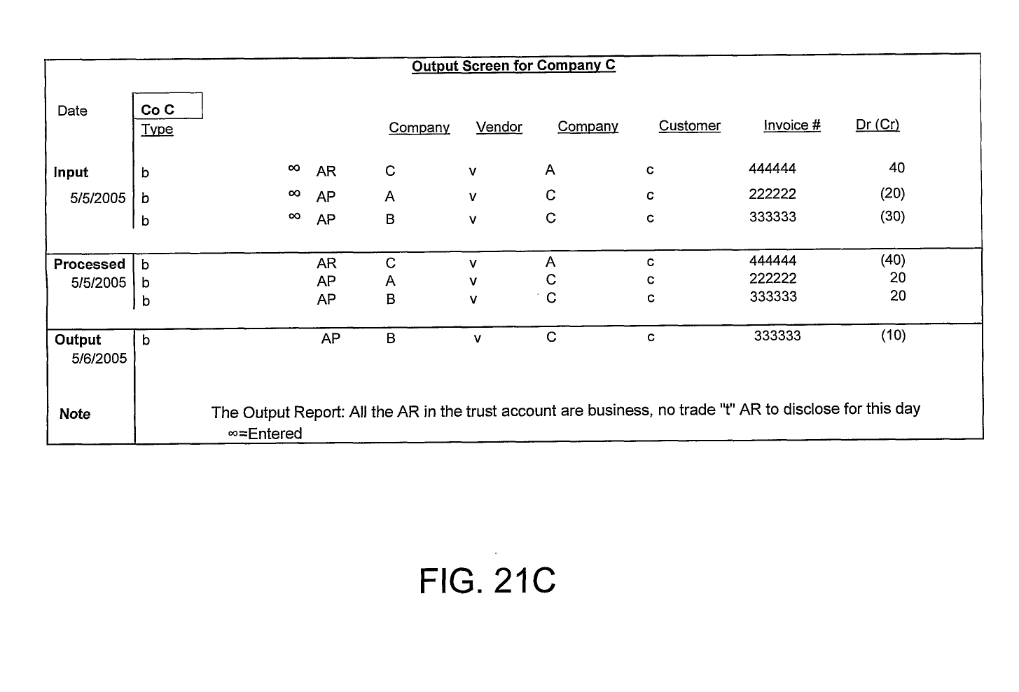

FIGS. 14-19 are diagrams showing a continuation of the process with respect to companies B and C. FIG. 20 is a diagram illustrating the result of the trading execution process for companies A, B, and C. FIGS. 21A, 21B, and 21C are diagrams illustrating exemplary output reports for the trading process for companies A, B, and C.

A method and system for reducing pendency of accounts receivable has been disclosed. The APART trading system 100 of the present invention minimizes the lag time of 30-60 days from sale to AR collection, and allows companies to retire their own short term liability. Moreover, the APART solution creates an innovative cashless payment that elevates AR to the status of cash, while incurring no interest expense, APART uses unpaid invoices (AP balances) and uncollected invoices (AR balances) in lieu of cash; since cash is not used, which in turn, increases cash flow for each company, and enables the companies to use the cash for longer term investments. In sum, the APART trading system results in a net gain for all participants. A win/win situation.

The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

1. A computer-implemented method for reducing pendency for accounts receivable, comprising:
receiving by a trading service accessible over a network a submission of accounts receivable (AR) and accounts payable (AP) from a plurality of companies; and
paying the AP of each of the companies, to an extent of available AR, by the trading service trading the AP for the AR with other companies in the network, thereby paying the AP through a non-cash settlement.

2. The method of claim 1 wherein trading the AP for the AR further includes the trading service placing the AP and AR into an account and performing the trading within the account.

3. The method of claim 2 wherein the account comprises a one of a trade account or a trust account.

4. The method of claim 2 wherein receiving the submission of AR and AP includes receiving AR and AP records and performing an input validation test on the AR and AP records to ensure that the AR and AP records are valid and balanced.

5. The method of claim 4 wherein ensuring that the AR and AP records are balanced includes making sure that for every AP there is a corresponding AR for each company.

6. The method of claim 5 wherein the validation process further includes placing the AR and AP records that pass the validation test in the account.

7. The method of claim 6 wherein the AR and AP records added to the account and traded are designated as one type to indicate business AR/AP, which is in the original data received from the client companies, and designated as a second type to indicate AR/AP for each company that were gained through a trade in the account.

8. The method of claim 6 further including placing any unmatched AR or AP at completion of the validation process in an orphan record table for matching during a subsequent validation and processing phase.

9. The method of claim 2 wherein paying the AP of each of the companies includes identifying payees and payers in each AR and AP transaction, and paying the AP with AR between the identified payers and payees.

10. The method of claim 9 wherein the trading service reduces an AP of the payer by the amount of the available AR by transferring the AR owned by the payer to the payee.

11. The method of claim 9 wherein the trading service performs a settlement and adjustment process in which for each payee, the payee's account is adjusted for each of the trades, and any self debt as a result of a trade in which a client exchanges AR/AP to itself is canceled.

12. The method of claim 11 wherein the trading service adjusts balances for each payee by transferring the AR balance to an account of the payee, and adjusts the corresponding AP, resulting in the payee assuming the new AR.

13. The method of claim 12 wherein the trading application reduces the AR of the payee involving the payer by an amount of AR transferred to the payee from the payer.

14. The method of claim 11 further including performing a control balance process for ensuring a zero balance is maintained after processing each trade and its settlement.

15. The method of claim 1 wherein after paying the AP of each of the companies, the trading service provides reports to each of the companies informing the company of the trades of AR and AP.

16. The method of claim 1 wherein the network comprises one of an extranet and an Internet.

17. A system for reducing pendency for accounts receivable, comprising:
a plurality of client companies, each agreeing to trade accounts receivable (AR) and accounts payable (AP) among themselves; and
a trading service accessible over a network by the plurality of client companies, the trading service functional for:
receiving a submission of the AR and AP from the plurality of client companies; and
paying the AP of each of the plurality of client companies, to an extent of available AR, by trading the AP for the AR with other of client companies in the network, thereby paying the AP through a non-cash settlement.

18. The system of claim 17 wherein the trading service includes a trading application that controls data transmissions between the client companies and the trading service, validates input data, executes the AR/AP trades, provides settlement and control balances, and reports the results of the trades to the client companies

19. The system of claim 18 wherein the trading service further includes an account for placing and trading the AP for the AR.

20. The system of claim 19 wherein the account comprises a trust.

21. The system of claim 18 wherein receiving the submission of AR and AP includes receiving AR and AP records and performing an input validation test on the AR and AP records to ensure that the AR and AP records are valid and balanced.

22. The system of claim 21 wherein ensuring that the AR and AP records are balanced includes making sure that for every AP there is a corresponding AR for each company.

23. The system of claim 22 wherein the validation process further includes placing the AR and AP records that pass the validation test in the account.

24. The method of claim 23 wherein the AR and AP records added to the account and traded are designated as one type to indicate business AR/AP, which is in the original data received from the client companies, and designated as a second type to indicate AR/AP for each company that were gained through a trade in the account.

25. The system of claim 24 wherein the validation test includes placing any unmatched AR or AP at completion of the validation process in an orphan record table for matching during a subsequent validation and processing phase.

26. The system of claim 18 wherein paying the AP of each of the companies includes identifying payees and payers in each AR and AP transaction, and paying the AP with AR between the identified payers and payees.

27. The system of claim 26 wherein the trading service reduces an AP of the payer by the amount of the available AR by transferring the AR owned by the payer to the payee.

28. The system of claim 26 wherein the trading service performs a settlement and adjustment process in which for each payee, the payee's account is adjusted for each of the trades, and any self debt as a result of a trade in which a client exchanges AR/AP to itself is canceled.

29. The system of claim 28 wherein the trading service adjusts balances for each payee by transferring the AR balance to an account of the payee, and adjusts the corresponding AP, resulting in the payee assuming the new AR.

30. The system of claim 29 wherein the trading application reduces the AR of the payee involving the payer by an amount of AR transferred to the payee from the payer.

31. The system of claim 28 wherein the trading application performs a control balance process for ensuring a zero balance is maintained after processing each trade and its settlement.

32. The system of claim 18 wherein after paying the AP of each of the companies, the trading service provides reports to each of the companies informing the company of the trades of AR and AP.

33. The trading service of claim 18 wherein the trading service includes internal application server for running the trading application, and a rules database containing rules and covenants that control the operations of the trading service.

34. The trading service of claim 33 wherein trading application further includes a rules component representing parameters within which the trades take place, and an operational component defining the day-to-day functioning of the trading system.

35. A computer-readable medium containing program instructions for reducing pendency for accounts receivable, the program instructions for:
receiving by a trading service accessible over a network a submission of accounts receivable (AR) and accounts payable (AP) from a plurality of companies; and
paying the AP of each of the companies, to an extent of available AR, by the trading service trading the AP for the AR with other companies in the network, thereby paying the AP through a non-cash settlement.

36. A computer-implemented method for reducing pendency for accounts receivable, wherein a plurality of collaborative companies submit entries on an accounts payable (AP) ledger and an accounts receivable (AR) ledger representing short-term liability AP and short-term asset AR, respectively, to a server on a network, the method comprising:
trading for a particular one of the companies, one or more of the short-term liability AP owed to a second company by transferring one or more of short-term asset AR to the second company, thereby paying the AP through a non-cash settlement; and
reporting results of the trade to the respective companies.

37. A computer-implemented method for settling accounts payable (AP), comprising:
receiving by a service on a network, a submission from a first company of a short-term asset accounts receivable (AR), and a short-term liability accounts payable (AP) that is owed to a second company; and
settling the short term liability for the first company by transferring the short-term asset AR to the second company.
